(19) United States
(12) Patent Application Publication
(10) Pub. No.: US 2013/0293121 A1
(43) Pub. Date: Nov. 7, 2013

(54) DISPLAY CONTROLLER AND DISPLAY SYSTEM

(71) Applicant: Apical Limited, London (GB)

(72) Inventor: Chesnokov Viacheslav, Loughborough (GB)

(21) Appl. No.: 13/914,282

(22) Filed: Jun. 10, 2013

Related U.S. Application Data
(63) Continuation of application No. PCT/GB2011/052454, filed on Dec. 9, 2011.

(30) Foreign Application Priority Data
Dec. 10, 2010 (GB) 1020983.1
Jan. 12, 2011 (GB) 1100483.5

(51) Int. Cl. H05B 37/02

(52) U.S. Cl. CPC H05B 37/0218
USPC 315/158

(57) ABSTRACT

A display controller controls the display luminance of a display device in dependence on the ambient light level. It also controls the amount of the dynamic range compression of the input display data, the amount of compression depending on the ambient light level. The dynamic range of the display data is compressed to match the dynamic range of the display device. The dynamic range of the display device depends on the ambient light level and the display luminance.

### CROSS-REFERENCE TO RELATED APPLICATIONS

This application is a continuation under 35 U.S.C. §120 of International Application No. PCT/GB2011/052454, filed on Dec. 9, 2011, and published by the International Bureau in the English language as WO2012/076906 A1 on Jun. 14, 2012, which claims priority to (1) GB Application Number 1100483.5, filed on Jan. 12, 2011; and (2) GB Application No. 1020983.1, filed on Dec. 10, 2010. Each of the above-referenced patent applications is hereby incorporated by reference in its entirety.

### BACKGROUND OF THE INVENTION

1. Field of the Invention

The present invention relates to a display controller, a display system and a method of controlling a display device.

2. Description of the Related Technology

U.S. patent application Ser. No. 7,259,769 describes a display system comprising a display controller and a display device having a backlight. The image to be viewed on the display device may be affected by ambient light. In the known display system the display controller controls the luminance of the display device by adjusting the power delivered to the backlight in dependence on the amount of ambient light. Under dark ambient conditions the display luminance is set low.

As ambient light increases, the display luminance is increased until a certain maximum is reached. Gamma correction is applied to compensate the perceived image brightness and thereby enhance the range of display backlight brightness adjustment that may be applied to conserve power.

A disadvantage of this type of display controller is that the viewing experience over a wide range of ambient light conditions is unsatisfactory. It is an object of the invention to provide a display controller giving an improved viewing experience.

### SUMMARY

In accordance with one aspect of the present invention, there is provided a display controller comprising a luminance control unit for controlling a display luminance of a display device, a dynamic range compression engine for compressing a dynamic range of display data, and an input for an ambient light signal representing an ambient light level, the ambient light signal input being connected to the luminance control unit and to the dynamic range compression engine, wherein the luminance control unit is arranged to adjust the display luminance in dependence on the ambient light signal and the dynamic range compression engine is arranged to apply an amount of dynamic range compression dependent on the ambient light signal for compressing the dynamic range of the display data to match a dynamic range of the display device, the dynamic range of the display device being dependent on the ambient light level and the display luminance.

The unsatisfactory viewing experience of the prior art display system is due to the fact that the control of the luminance of the display device is insufficient to cope with the wide range of ambient light levels common in surroundings of display devices. In the display device according to certain embodiments of the invention both the luminance of the display device and the amount of dynamic compression of the display data representing the image, i.e. the source content to be displayed, are controlled in dependence on the ambient light level. The matching of the dynamic range of the display data to the dynamic range of the display device allows a constant effective dynamic range across a wide range of ambient light conditions, thereby maintaining a constant visibility of image detail in shadows, mid-tones and highlights. This provides a satisfactory viewing experience of the image displayed over a wide range of ambient light level and gives an improvement over the prior art display systems.

Preferably, the dynamic range compression of the display data is equal to the dynamic range of the display data minus the dynamic range of the display device. This amount of dynamic range compression achieves an optimum adaptation of the display data to the available dynamic range of the display device, thereby providing the best achievable visibility of image details at any ambient light level. The ‘minus’ sign is used because the dynamic ranges are expressed as logarithms of luminance levels.

A good viewing experience is obtained if he luminance control unit is arranged to increase the display luminance with increasing ambient light level in a first range of the ambient light level, in particular if the luminance is changed in a range of the ambient light level over which the human eye is strongly sensitive to luminance changes. Such luminance changes over this range lead to a comfortable viewing experience where the display is perceived as being neither too bright nor too dark in comparison to its surroundings. Changes of luminance at other ambient light levels may lead to viewer discomfort and inefficient use of display power to maintain display dynamic range. The first range has advantageously a minimum value determined by the ambient light level where an observer's visual system starts to adapt to the ambient light level.

In another embodiment the first range has a maximum determined by a power consumption constraint. The power constraint may be the maximum available power of the display device, thereby determining the maximum of the first range. The power constraint may also be a value lower than the maximum available power, for example for reducing the power consumption of the display device, which may be used to increase the battery life of a portable display device. The power consumption constraint may be adjustable to meet various demands, such as high luminance when connected to a mains supply and long battery life when operating in portable mode. The dynamic range compression engine may be arranged to increase the compression strength with increasing ambient light level in a second range of the ambient light level. The viewing experience is improved if the dynamic range compression of the display data is adjusted as a function of the ambient light level over a second range of the ambient light level.

In a yet another embodiment the dynamic range compression engine is arranged to increase the compression strength with increasing ambient light level in a second range of ambient light and the second range has a minimum that is smaller than the minimum of the first range. The dynamic range compression is advantageously used in a range of ambient light levels starting below the first range. A seamless viewing experience of the displayed image can be obtained if dynamic range compression is used starting at an ambient light level that begins to affect the visibility of image detail in shadows due to reflection of ambient light by the display. When the ambient light reaches the level where an observer's visual system starts to adapt to the ambient light level, the dynamic range compression can be kept constant by increasing the luminance of the display device with further increasing ambient light level. The transition from increasing dynamic range compression to increasing luminance can be made smoothly.

In another embodiment the dynamic range compression engine is arranged to increase the compression strength with increasing ambient light level in a second range of ambient light and the second range has a minimum that is larger than the minimum of the first range. The maximum of the second range may be equal to or larger than the minimum of the first range. When the ambient light level increases above the level where the luminance of the display device reaches its maximum value, the dynamic range of the display data can be adapted to the dynamic range of the display device by increasing the dynamic range compression with increasing ambient light level. The transition from increasing luminance to increasing dynamic range compression can be made smoothly.

The dynamic range compression engine is advantageously arranged for altering luminance values of pixels in dark regions while leaving the luminance values of pixels in brightest regions of the display data substantially unchanged. When the ambient light increases, a non-adapted image becomes progressively less visible from the darkest regions upwards; the first details to be lost are in the deepest shadows. Hence, the darkest regions should be selectively adjusted; bright regions are preferably substantially unchanged to avoid a loss of image quality. At low ambient light levels, the midtones are preferably also substantially unchanged. A selective adjustment can be performed using a spatially-varying compression algorithm.

Inventive embodiments also relate to a display system including a display device and a display controller. The luminance of a display device wherein each picture element modulates light, such as a transmissive or transflective display device, may be adjusted by controlling the intensity of the backlight of a such a device, for example an LCD electrophoretic or electrowetting display device. Alternatively, the luminance of a display device wherein light is generated in each picture element may be adjusted by controlling the luminance of each of the picture elements, for example in an OLED or plasma display device.

In accordance with one aspect of the present invention, there is provided a method of controlling a display device, the method comprising the steps of controlling a display luminance of the display device in dependence on an ambient light level and controlling dynamic range compression of display data using an amount of dynamic range compression dependent on the ambient light level, the dynamic range of the display date being compressed to match a dynamic range of the display device, the dynamic range of the display device being dependent on the ambient light level and the display luminance.

Further features and advantages of the invention will become apparent from the following description of preferred embodiments of the invention, given by way of example only, which is made with reference to the accompanying drawings

### BRIEF DESCRIPTION OF THE DRAWINGS

FIG. 1 shows a display system according to one or more embodiments of the invention.

FIG. 2 shows three graphs explaining the operation of the display controller in accordance with one or more embodiments.

### DETAILED DESCRIPTION OF CERTAIN INVENTIVE EMBODIMENTS

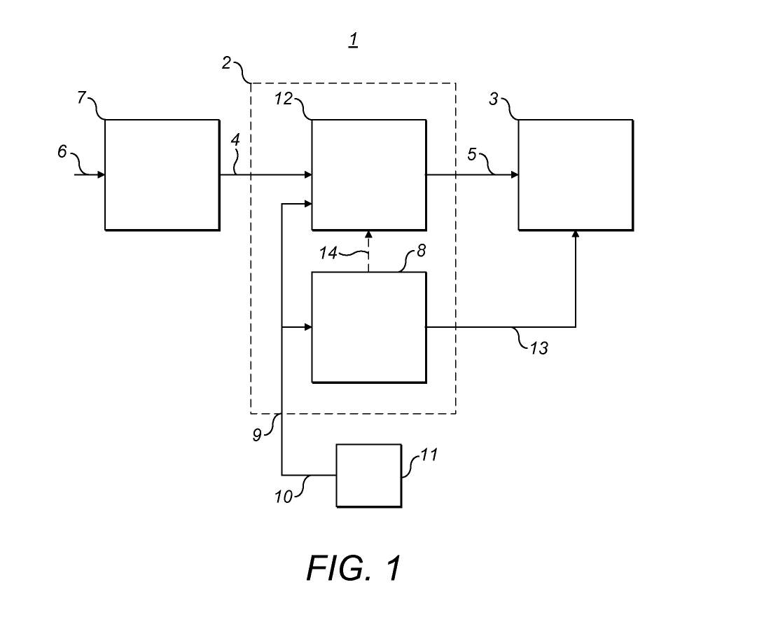

FIG. 1 shows a display system 1 according to one or more embodiments of the invention. The display system includes a display controller 2 and a display device 3 for displaying an image. Display data 4 representing the image is input to the display controller 2 and output as compressed display data 5 to the display device 3. Incoming image data 6 may be converted to the display data 4 by a processor 7, the conversion including for example video or image decoding.

The display controller 2 includes a luminance control unit 8 for controlling the luminance of the display device 3. The display controller 2 has an input 9 for an ambient light signal 10 representing an ambient light level relevant for viewing the image. The ambient light signal is connected to the luminance control unit 8.

The ambient light signal 10 is output by an ambient light sensor 11 that measures the ambient light level near the display device 3. The ambient light sensor may include one or more photo-detectors for measuring the ambient light level; the use of multiple sensors may increase the reliability of the measurement of diffuse ambient light. The level may be determined at the viewing side and/or the rear side of the display device 3, as known from, inter alia, U.S. Pat. No. 5,760,760.

The display controller 2 also includes a dynamic range compression engine 12 for compressing the dynamic range of the display data 4. The ambient light signal 10 is input to the dynamic range compression engine. The dynamic range compression engine 12 and/or the luminance control unit 8 may be integrated with the processor 7.

When the display device 3 is of a light-modulating type, it usually includes a backlight. In that case the luminance of the display device can be controlled by the luminance control unit 8 outputting a luminance control signal 13 for setting the intensity of the backlight. When the display device 3 is of a type wherein light is generated in each picture element, the luminance control unit may instead output a luminance control signal 14, connected to the dynamic range compression engine 12 or to the processor 7. In that case the luminance of the display device 3 can be controlled by the luminance level coded in the compressed display data 5.

The display device has a dynamic range DR_{D}, also called effective contrast ratio, defined as:

$${DR}_{0} = {log}_{2} ( \frac{{L}_{W}}{{L}_{B}} ) \qquad ( 1 )$$

where log₂(x) is the logarithm of x to the base 2. The white level L_{w} is the display luminance, i.e. the luminance when the compressed display data 5 encode for a white display pixel. The white level is dependent on the luminance control signal 13 or 14. The black level L_{B} is the minimum luminance that is required to produce a detail just visible in a black region of the image, i.e. the first gray level above the black level that is discernable for a viewer.

The value of L_{B} depends on both the display device and the ambient light. Factors of the display device may include light leakage from a backlight through a pixel in a black state and a limited resolution of the display controller 2 and/or the processor 7. The ambient light affects the value of L_{B} by reflection on the display device 3; the first gray level must be visible above this background light. The ambient light also affects the viewer of the display device when his visual system adapts to the ambient light, for example by adjusting the aperture of eye diaphragm and/or the sensitivity of the retina. A smaller diaphragm captures less light and causes a higher value of L_{B}. A limited narrow-angle adaptivity of the eyes may also increase the value of L_{B}.

The image to be displayed, i.e. the source content, may include text, graphics, photos and videos. The dynamic range of graphics is usually low, and exceeded by the dynamic range DR_{D} of the display device. In contrast, photos, videos and 3D-rendered games may have a high dynamic range, possibly up to 4000:1, that may even exceeds the dynamic range of a high-quality display device in totally dark surroundings. The maximum dynamic range of the source content to be displayed is denoted by DRs. The source content is represented by the display data 4 in FIG. 1.

The dynamic range of the source content DRs may be reduced by dynamic range compression to a reduced dynamic range DR_{R}. Dynamic range compression is also known as tone mapping. The compression can be carried out by a known algorithm, such as ORMIT, disclosed in U.S. Pat. No. 7,302,110.

In the display system of FIG. 1 the dynamic range compression engine 12 carries out the compression and converts the incoming display data 4 having a source dynamic range DRs to the outgoing compressed display data 5 having a reduced dynamic range DR_{R}. The amount of dynamic range compression is denoted by DRC. It should be noted that in specific circumstances no compression is carried out and the display data 4 and the compressed display data 5 have the same dynamic range.

The dynamic range compression engine preferably employs a transfer function that varies spatially across the image. Advantageously the transfer function is continuous and smoothly-varying in both spatial and luminance dimensions. The dynamic range compression engine should alter the luminance of pixels in dark regions of the image and mid-tones while leaving the luminance of pixels in brightest regions substantially unchanged. The ORMIT algorithm combines said smooth variation and the luminance alteration in dark and mid-tone regions of the image.

The display controller adapts the source content DRs such that a viewer has a seamless viewing experience of the content when the ambient light level changes, compared to the reference case of dark viewing conditions. The viewer will be largely unaware of the changes being made to match the dynamic range of the source content and the available dynamic range of the display device as determined by the level of ambient light. His impression of the content will be the same as that of the reference image in dark viewing conditions, largely independent of the ambient light level.

The matching is carried out by adjusting the amount of dynamic range compression of the source content and the luminance of the display device, both in dependence on the ambient light level. The display controller aims to achieve the following equality:

DR_{R}=μDR_{D} (2)

where μ is a constant. The value of μ is typically equal to or near unity, but may be set above or below this value according to aesthetic preferences. A value smaller than one reduces the contrast of the image displayed, which may be used to hide noise in the source content.

Equation (2) can be rewritten as:

$${DR}_{S} - DRC = μ {log}_{2} ( \frac{{L}_{W}}{{L}_{B}} ) \qquad ( 3 )$$

The value of the black level L_{B} depends on the amount of ambient light LA. The display controller aims to achieve the equality in equation (3) by adjusting the amount of dynamic range compression DRC and the white level Lw, both in dependence on the ambient light level LA. The white level is adjusted by the luminance control signal 13 or 14.

The settings of parameters to satisfy equation (3) can be determined using an analytical or experimental method. In an analytical method the relation L_{B}=rL_{A} can be used, where r is the reflectivity of the display device. The value of r can be measured in a known way. In this method equation (3) gives a closed expression for DRC dependent on L_{A}.

In an experimental method, an image is selected that is representative of the type to be shown on the display device. The image has a just noticeable feature, i.e. a feature having a just visible gray level in a dark region. At a given ambient light level LA and a specific setting of the luminance of the display device, and hence of the white level L_{w}, the amount of dynamic range compression DRC is adjusted to make the feature just visible. This is done visually and appears to be accurate and reproducible between different observers.

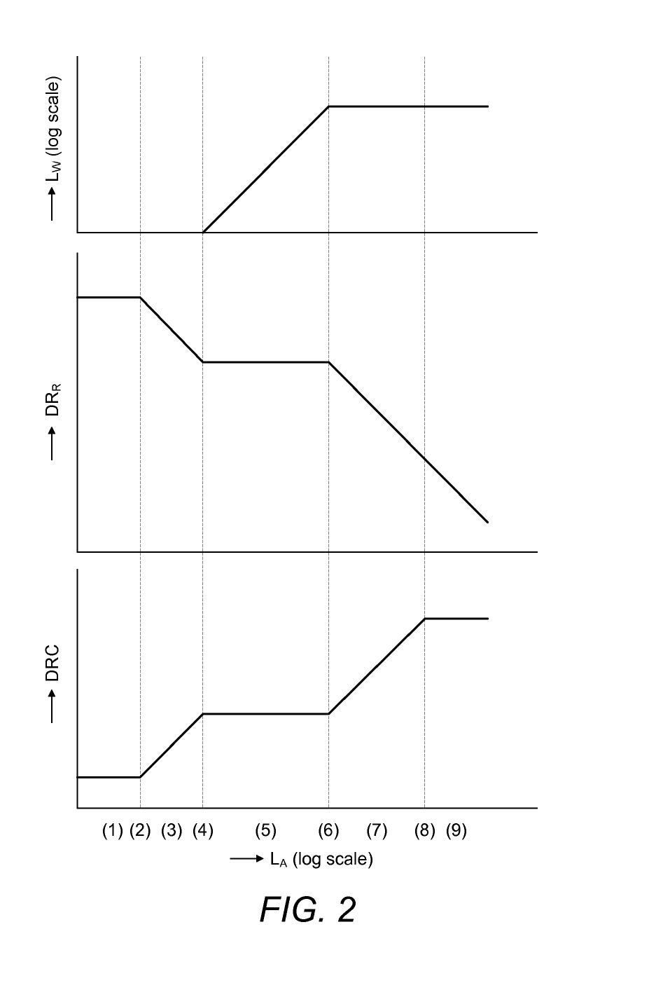

FIG. 2 shows an example of the operation of the display controller according to one or more embodiments of the invention. The horizontal axis shows the ambient light level LA on a logarithmic scale. The bracketed numbers along the axis are labels representing ambient light levels; the ambient light level pertaining to label (x) is LAₓ. The vertical axis for the bottom and middle graph in FIG. 2 shows the dynamic range compression DRC and the reduced dynamic range DR_{R}, respectively. DRC and DR_{R} are drawn on a linear scale, as they relate to the logarithm of light levels. The vertical axis of the top graph shows the white level L_{w} on a logarithmic scale.

FIG. 2 is based on the assumption that the black level L_{B} depends mainly on reflection of ambient light on the screen of the display device and can be equated to (r LA), where r is the reflectivity of the screen. When other factors influence the black level, the operation of the display controller can be adapted accordingly. FIG. 2 distinguishes four regimes with different ambient light levels, which will be discussed in the following paragraphs.

The first regime, having ambient light levels up to LA2, relates to very dark conditions where the ambient light has an insignificant effect on the black level L_{B}. The white level L_{w} and hence the display luminance, is constant in the first regime and is set at a relatively low value to avoid discomfort to the viewer who has adapted his visual system to the low ambient light level. The amount of dynamic range compression DRCo applied to the display data is also constant. It may be zero when the dynamic range of the source content and the display device is similar or equal. A non-zero DRC may be applied if the dynamic range of the source content is higher than that of the display device, which may reveal shadow or highlight detail which the eye would otherwise not perceive due to limited narrow/angle adaptivity. The setting of DRCo to obtain optimal perceived image quality in the first regime may be a trade-off between content visibility and compression noise visibility.

In the second regime, for ambient light levels in the range from LA₂ to LA4, ambient light reduces the dynamic range of the display device and the smallest details in the image would be lost without further measures. The level LA2, where the ambient light becomes significant above other factors limiting dynamic range, is defined by equation (3where is μ is set to unity and L_{B2} to rL_{A2}:

$${DR}_{S} - {DRC}_{B} = {log}_{2} ( \frac{{L}_{W 2}}{{rL}_{A 2}} ) \qquad ( 4 )$$

The ambient light reduces the dynamic range of the display device from below. The viewing experience is maintained in the second regime by decreasing the dynamic range DR_{R} of the display data and keeping the luminance of the display device Lw constant at its minimum value. Hence, the dynamic range compression DRC for an ambient light level LA₃ in the range LA₂ to LA₄ is given

$$DRC ( {L}_{A 3} ) = {DRC}_{0} + {log}_{2} ( \frac{{L}_{A 3}}{{L}_{A 2}} ) , \qquad ( 5 )$$

shown by the increase of DRC and decrease of DRR between labels (2) and (4) in FIG. 2. The effect of ambient light reflecting from the screen can be reduced by an anti-reflection coating on the screen. This may move the beginning of the second regime, LA2, to a higher level and can even make the second regime superfluous.

The third regime starts at ambient light level LA4. At that level the visual system of the viewer starts to adapt to the ambient light level, reducing the visibility of details in black areas of the image. The loss of dynamic range from below is compensated in the third regime by increasing the luminance of the display device increases linearly with the ambient light level, thereby maintaining the dynamic range DRD of the display device. This is shown in the top graph of FIG. 2 by the increase of Lw between labels (4) and (6).

In the third regime, in the range from LA4 to LA6, the dynamic range of the display data is maintained at the level of LA4. Hence, the dynamic range compression for an ambient light level LAS in the third regime is

$$DRC ( {L}_{A5} ) = {DRC}_{0} + {log}_{2} ( \frac{{L}_{A 1}}{{L}_{A 2}} ) \qquad ( 6 )$$

The value of the ambient light level LA₆, i.e. the upper end of the third regime, may depend on power considerations as set out below. The extent of the third regime may be determined according to the range over which the human eye is strongly sensitive to changes in display luminance, resulting in a comfortable viewing experience for the user. Typical values for L_{A4} and L_{A6} are 20 lux and 200 lux, respectively.

A fourth regime may be implemented that starts at LA₆ and adjusts the display data for even higher ambient light levels. At levels upward from LA₆ the display luminance is at its maximum value and the ambient light further reduces the dynamic range of the display device. The display data is adapted to this reduced dynamic range by increasing the dynamic compression DRC for an ambient light level LA₇ in the fourth regime according to

$$DRC ( {L}_{A 7} ) = {DRC}_{0} + {log}_{2} ( \frac{{L}_{A 4}}{{L}_{A 2}} ) + {log}_{2} ( \frac{{L}_{A 7}}{{A}_{A 8}} ) \qquad ( 7 )$$

If necessary a fifth regime from an ambient light level of LAS upward may be implemented where both the luminance of the display device and the dynamic range compression are at their maximum values. The maximum value of the dynamic compression is

$$DRC ( {L}_{A 9} ) = {DRC}_{0} + {log}_{2} ( \frac{{L}_{A 4}}{{L}_{A 2}} ) + {log}_{2} ( \frac{{L}_{A 5}}{{L}_{A 6}} ) \qquad ( 8 )$$

where LA9 is an ambient light level in the fifth regime. The maximum dynamic range compression, and thereby the value of LAS, is determined by the limitations of the dynamic range compression algorithm in preserving a high quality, natural image. The quality of the image displayed will deteriorate for increasing ambient light levels in the fifth regime.

The value of Lw₆, the maximum white level, and thereby the upper end LA6 of the third regime, may be determined by the maximum available display luminance of the display device. Alternatively, a power-management policy may permit a user of the display system to reduce the display luminance to a lower value than the maximum available display luminance, e.g. to 50%. A graphics interface may be provided with a slider control for setting the display luminance between a minimum and a maximum value. A lower display luminance will increase the time between battery recharges for a portable display device.

The above policy may be combined with a so-called content-adaptive luminance control, where the display luminance or white level Lw(t) is varied temporally based on a statistical analysis of the brightness of the image:

$${L}_{W} ( t ) = \frac{{L}_{W}}{P ( t )} \qquad ( 9 )$$

where P(t) is a power saving factor and L_{w} is the maximum available luminance of the display device. In a combined implementation, L_{w} is set according to the scheme of FIG. 2 and the temporal deviations calculated according to the specific content-adaptive algorithm. The time-dependent dynamic range compression is then given by

DRC(t )=DRC+log₂(P(t) (10)

The example of operation in FIG. 2 may be modified by an empirical method of dynamic range estimation, based on a visual comparison of the appearance of a high-contrast image on the display device at a particular ambient light level and that of the same image displayed in a dark ambient. The balance between the display luminance and the amount of dynamic range compression can be determined for any range based on the visual comparison. In a particular range the dynamic range compression or the luminance may be increased with increasing ambient light level or the luminance and the dynamic range compression may both be increased with increasing ambient light level.

The example of operation in FIG. 2 shows discontinuities in the gradient of the dynamic range compression DRC versus ambient light level LA. Alternatively, the discontinuities may be replaced by continuous functions, providing overlap between the regimes.

The operation of the display controller requires the application of an amount of dynamic range compression DRC. The amount of dynamic range compression is controlled by parameters of the dynamic range compression algorithm being used. The following example relates to input display data 4 with a power-law gamma of 2.2. Any dynamic compression algorithm may be associated with a strength parameter, which controls the amount of dynamic range compression applied to the image in a linear manner between the original image and an image to which has been applied the maximal dynamic range compression achieved by the algorithm for a given set of parameters. Defining the local gain applied to a given pixel as the ratio of the output pixel luminance to the input pixel luminance, the amount of dynamic range compression is given by the ratio of the largest to the smallest local gain for a particular image. To control this quantity, the maximum possible gain Gainₘₐₓ is defined that can be applied by the algorithm. This varies from algorithm to algorithm but is always straightforwardly obtained. In the case of the ORMIT algorithm, it is achieved by setting the ORMIT parameter a=1. The control is achieved by defining a further parameter, Strength, which varies between 0 and 1. This gives the following equation for the largest local gain Gain₁:

Gain=Strength*(Gainₘₐₓ−1)+1 (11)

In practical cases, the smallest local gain is unity, so the amount of dynamic range compression is equal to Gain₁. The amount of DRC can therefore be varied between its minimum and maximum values by adjustment of the parameter Strength as follows:

$$Strength = \frac{{2}^{\frac{DRC}{2 π}} - 1}{{Gain}_{max} - 1} \qquad ( 12 )$$

This equation provides the Strength required for an algorithm such as ORMIT algorithm to achieve a specific DRC as, e.g., in the above equations (5) to (8).

The above embodiments are to be understood as illustrative examples of the invention. Further embodiments of the invention are envisaged. For example, for displays which are transflective or otherwise include a reflective element, the dynamic range of the display device may increase with increasing ambient light in bright conditions. In this case, the above method can be straightforwardly modified to satisfy equation (3) under such conditions. In another embodiment, a photo-sensor is not used to measure ambient light but the user is provided with a control to allow for manual setting of ambient light level, for example the user may choose between “indoor” and “outdoor” settings, with “indoor” setting corresponding to an ambient light level of approximately 50 lux and “outdoor” to approximately 2000 lux. In another embodiment, temporal filtering which may incorporate a standard method of hysteresis is applied to the ambient light level measurement, such that the changes to display luminance and dynamic range compression are made smoothly in time even in cases where the ambient light level measurement changes very rapidly, in order to avoid visible flicker. In another embodiment, the display luminance is increased step-wise in the third regime rather than in a continuous fashion also to avoid visible flicker in conditions where the positioning or accuracy of the photo sensor is insufficient to yield a sufficiently precise measurement of ambient light in all conditions. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A display controller comprising a luminance control unit for controlling a display luminance of a display device, a dynamic range compression engine for compressing a dynamic range of display data, and an input for an ambient light signal representing an ambient light level, the ambient light signal input being connected to the luminance control unit and to the dynamic range compression engine,
wherein the luminance control unit is arranged to increase the display luminance with increasing ambient light level in a first range of the ambient light level, and
wherein the dynamic range compression engine is arranged to increase the compression strength with increasing ambient light level in a second range of ambient light level for compressing the dynamic range of the display data to match a dynamic range of the display device, the dynamic range of the display device being dependent on the ambient light signal and the display luminance,
wherein the second range having a minimum that is smaller than the minimum of the first range or the second range having a minimum that is larger than the minimum of the first range.

2. The display controller of claim 1, wherein the second range has a minimum that is smaller than the minimum of the first range, and wherein a further second range has a minimum that is larger than the minimum of the first range.

3. The display controller of claim 1, wherein the dynamic range compression of the display data is equal to the dynamic range of the display data minus the dynamic range of the display device.

4. The display controller of claim 1, wherein the first range has a minimum value determined by the ambient light level where an observer's visual system starts to adapt to the ambient light level.

5. The display controller of claim 1, wherein the first range has a maximum determined by a power consumption constraint.

6. The display controller of claim 1, wherein the dynamic range compression engine is arranged for applying a spatially-varying compression algorithm.

7. The display controller of claim 1, wherein the dynamic range compression engine is arranged for altering luminance values of pixels in dark regions while leaving the luminance values of pixels in brightest regions of the display data substantially unchanged.

8. The display controller of claim 1, wherein the dynamic range compression engine is arranged for applying an ORMIT algorithm.

9. The display controller of claim 1, wherein the display controller is part of a display system comprising a display device and the display controller.

10. The display system of claim 9, wherein the display device is transflective.

11. A method of controlling a display device, the method comprising:
increasing a display luminance of the display device with increasing ambient light level in a first range of the ambient light level; and
increasing compression strength of a dynamic range compression engine with increasing ambient light level in a second range of ambient light level, a dynamic range of the display data being compressed to match a dynamic range of the display device, the dynamic range of the display device being dependent on the ambient light level and the display luminance,
the second range having a minimum that is smaller than the minimum of the first range or the second range having a minimum that is larger than the minimum of the first range.

12. The method of claim 11, wherein the second range has a minimum that is smaller than the minimum of the first range, and wherein a further second range has a minimum that is larger than the minimum of the first range.

13. The method of claim 11, wherein the dynamic range compression of the display data is equal to the dynamic range of the display data minus the dynamic range of the display device.
